(19) United States
(12) Patent Application Publication
(10) Pub. No.: US 2020/0247443 A1
(43) Pub. Date: Aug. 6, 2020

(54) HAND CARTS TRANSPORTING GAS CYLINDERS

(71) Applicant: The Macumber Company, Inc., Elkhart, IN (US)

(72) Inventor: Dennis R VANCE, Edwardsburg, MI (US)

(21) Appl. No.: 16/784,352

(22) Filed: Feb. 7, 2020

Related U.S. Application Data
(63) Continuation of application No. 15/985,094, filed on May 21, 2018.
(60) Provisional application No. 62/511,416, filed on May 26, 2017.

(51) Int. Cl. B62B 1/26; B62B 1/04

(52) U.S. Cl. CPC B62B 1/264; B62B 1/042

(57) ABSTRACT

The present invention involves a device for holding and transporting a gas cylinder. The device, a hand truck, has an arm portion having a lip portion mounted thereon. The device also has at least one stabilizing peg mounted to the lip portion with two wheels mounted to the lip portion. The at least one stabilizing peg is sized and configured to engage the stabilizing ring of the gas cylinder placed on the lip portion. Optionally, a hook may be attached to the arm portion such that the hook may engage the gas cylinder. The arm portion may further comprise a handle portion pivotable between a raised position and a collapsed position. The handle portion is lockable in the raised position and the lowered position. The arm portion further comprises a cradle portion sized and configured to engage and stabilize the gas cylinder. The gas cylinder, having a stabilizing ring, may be tilted forward, and the hand truck may then be positioned to engage the cylinder. The gas cylinder may then be tilted back so that the stabilizing ring rests on the lip portion of the hand truck and is engaged by the at least one stabilizing peg. This allows for the tilting of the hand truck and cylinder backward so that the hand truck and cylinder may be wheeled freely.

### CROSS-REFERENCE TO RELATED APPLICATIONS

The present application is a continuation of U.S. patent application Ser. No. 15/985,094, filed May 21, 2018, which claims priority under 35 U.S.C. § 119 of U.S. Provisional Patent Application Ser. No. 62/511,416, filed May 26, 2017, the disclosures of which are incorporated by reference herein.

### BACKGROUND OF THE INVENTION

### Field of the Invention

Liquified petroleum gas, otherwise known as LPG or LP gas refers to mixtures of hydrocarbon gasses, typically propane and/or butane. LPG may be used for heating, cooking, powering devices, and refrigeration. LPG is commonly used in applications where installing infrastructure for delivering natural gas is impossible or impracticable such as in remote locations or in applications involving mobile devices such as powering forklifts or other vehicles, cooking in trailers or campers, or as a refrigerant in transportation.

### Description of the Related Art

Domestic and commercial applications using LPG commonly use gas stored and transported in metal cylinders such as shown in FIG. 12. The exact dimensions of the cylinder may vary by application and in some instances the metal cylinder is covered by a plastic shell. These cylinders 100 typically include a handle 120, one or more valves 130, a guard 110 for protecting the valves 130 from damage (which may include the handle 120), and a stand ring 140 so the round-bottomed cylinder 100 may stand upright. Transporting cylinders is typically either done by hand or using traditional carts, hand trucks, or dollies. Such methods risk damage to the cylinder from dropping (as the cylinders may be heavy) or falling/sliding off a traditional hand truck.

### BRIEF DESCRIPTION OF THE DRAWINGS

The above mentioned and other features and objects of this invention, either alone or in combinations of two or more, and the manner of attaining them, will become more apparent and the invention itself will be better understood by reference to the following description of an embodiment of the invention taken in conjunction with the accompanying drawings, wherein:

FIG. 1 shows a cart for transporting a cylinder according to an example of the disclosed technology.

FIG. 2 shows a cart for transporting a cylinder according to an example of the disclosed technology mounted to a forklift.

FIG. 3 shows two carts for transporting a cylinder according to an example of the disclosed technology.

FIG. 4 shows a cart for transporting a cylinder according to an example of the disclosed technology mounted to a forklift.

FIG. 5 shows two carts for transporting a cylinder according to an example of the disclosed technology.

FIG. 6 is a perspective view of a portion of a cart for transporting a cylinder according to an example of the disclosed technology.

FIG. 7 is a perspective view of a cart for transporting a cylinder according to an example of the disclosed technology.

FIG. 8 is a perspective view of a cart for transporting a cylinder according to an example of the disclosed technology.

FIG. 9 is a front view of a cart for transporting a cylinder according to an example of the disclosed technology.

FIG. 10 is a top view of a cart for transporting a cylinder according to an example of the disclosed technology.

FIG. 11 is a side view of a cart for transporting a cylinder according to an example of the disclosed technology.

FIG. 12 shows a typical LPG cylinder.

FIG. 13 is a side view of a cylinder engaged with a hand truck according to the disclosed technology.

FIG. 14 is a top view of the hand truck shown in FIG. 13.

Corresponding reference characters indicate corresponding parts throughout the several views. Although the drawings represent embodiments of the present invention, the drawings are not necessarily to scale and certain features may be exaggerated in order to better illustrate and explain the full scope of the present invention. The flow charts and screen shots are also representative in nature, and actual embodiments of the invention may include further features or steps not shown in the drawings. The exemplification set out herein illustrates an embodiment of the invention, in one form, and such exemplifications are not to be construed as limiting the scope of the invention in any manner.

### DETAILED DESCRIPTION

For the purposes of promoting an understanding of the principles of the claimed technology and presenting its currently understood best mode of operation, reference will now be made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would normally occur to one skilled in the art to which the claimed technology relates.

In the following examples reference will be made to cylinders used for the storage, transportation, and delivery of liquified petroleum gas or LPG. One of ordinary skill in the art would understand that the devices described in the present application could be adapted for use with other cylinders designed for the storage and transport of other types of compressed gasses such as oxygen, nitrogen, acetylene, compressed natural gas (CNG), liquified natural gas (LNG), and the like.

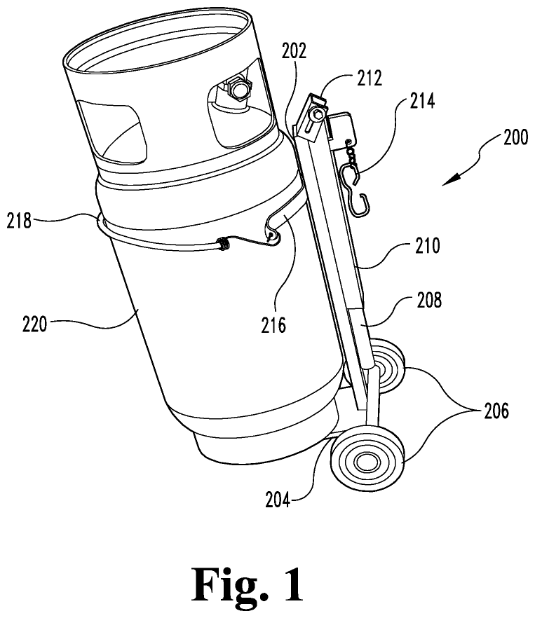

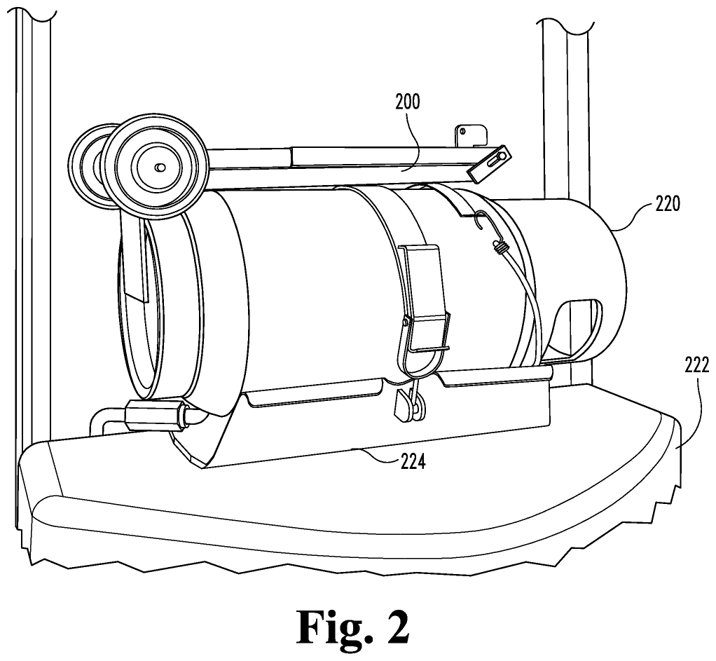

FIG. 1 shows an example of a hand truck for transporting an LPG cylinder according to the disclosed technology. In this example, hand truck 200 includes main arm 202 arranged generally perpendicular to a lip 204 or ledge portion. In other examples, a hand truck may include two or more vertical arm portions rather than a single arm portion. Pair of wheels 206 are positioned such that lip 204 rests on the ground when hand truck 200 is tipped forward and balances on wheels 206 which may roll freely when hand truck 200 is tipped backward. In this particular example, hand truck 200 further includes foldable arm extension 210 having grip 208 so hand truck 200 may be collapsed at pivot point 212 for storage or when otherwise not in use. Hand truck 200 also includes cradle 216 sized and configured to conform with the curve of a particular size of cylinder 220, one or more straps 218 for securing cylinder 220 to hand truck 200, and hook 214 for latching the hand truck to the handle portion and/or guard portion of a cylinder. Hand truck 200 may further include one or more stabilizing protrusions or pegs (not numbered) disposed on the lip such that the stand ring of the cylinder is prevented from sliding off lip 204. As seen in FIG. 2, cylinder 220 may be mounted to a vehicle such as forklift 222 using existing mounting bracket 224 while hand truck 200 is still attached to cylinder 200 in some examples of the disclosed technology.

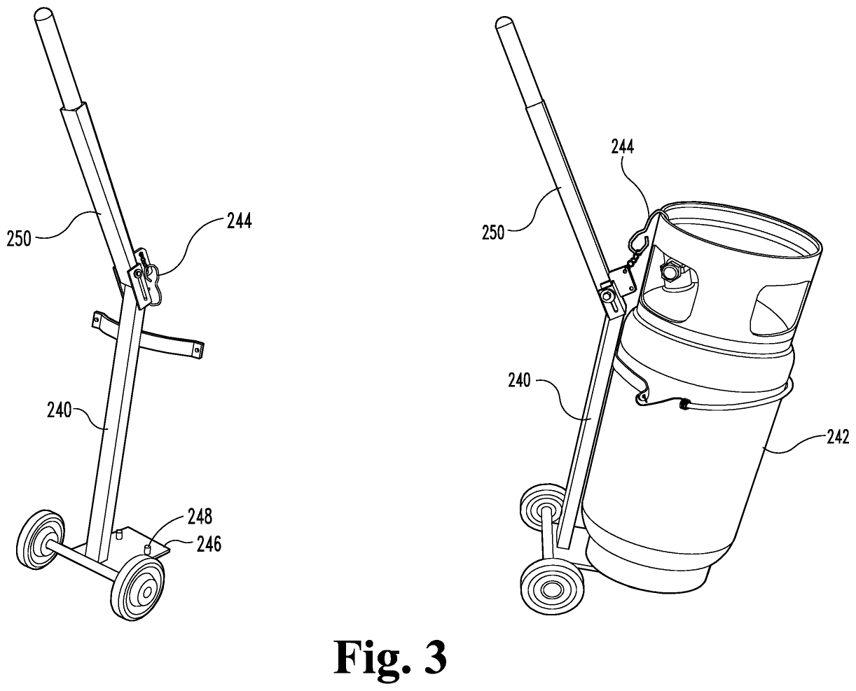

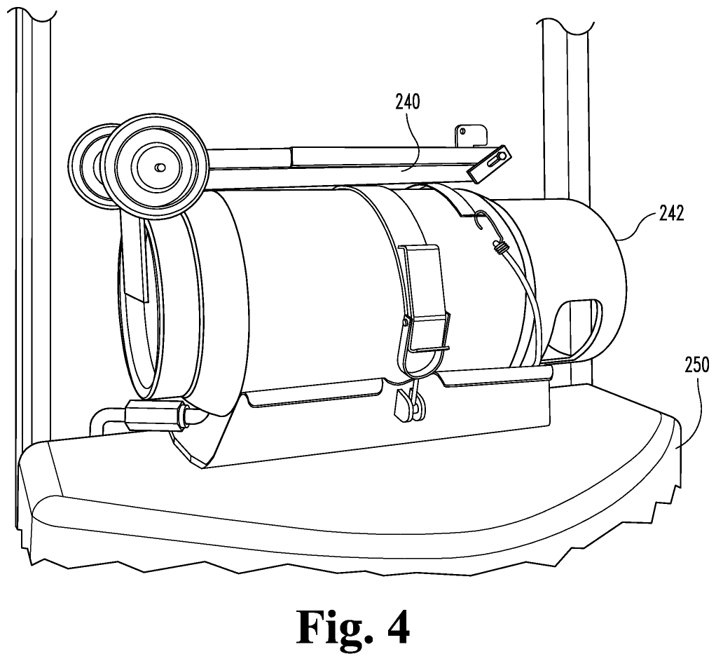

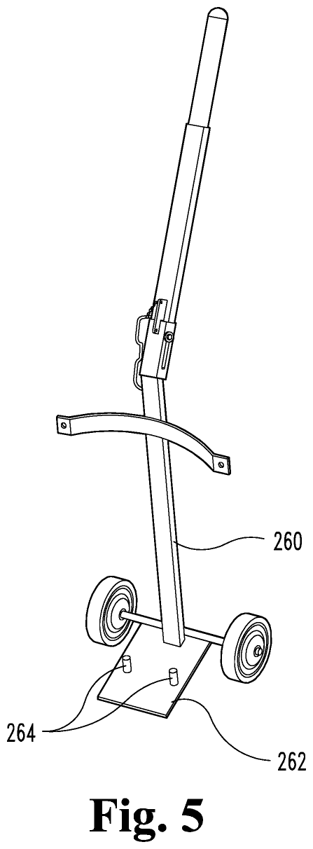

Another example of hand carts 240 according to the disclosed technology are shown in FIG. 3. In this example, arm extensions 250 are shown in the upright rather than the collapsed position. Hand cart 240 is shown attached to a cylinder 242 whereas another hand cart 240 is shown without. Securing hook 244 engaged with the protective guard of cylinder 242 prevents the cylinder from tipping off hand truck 240. Lip 246, having one or more stabilizing pegs 248, is visible on hand truck 240 without a cylinder. As seen in FIG. 4, in this example hand truck 240 may remain attached to cylinder 242 when the cylinder is mounted to a vehicle such as forklift 250. As shown in FIG. 5, hand truck 260 according to the disclosed technology may include a plurality of stabilizing pegs 264 on lip portion 262.

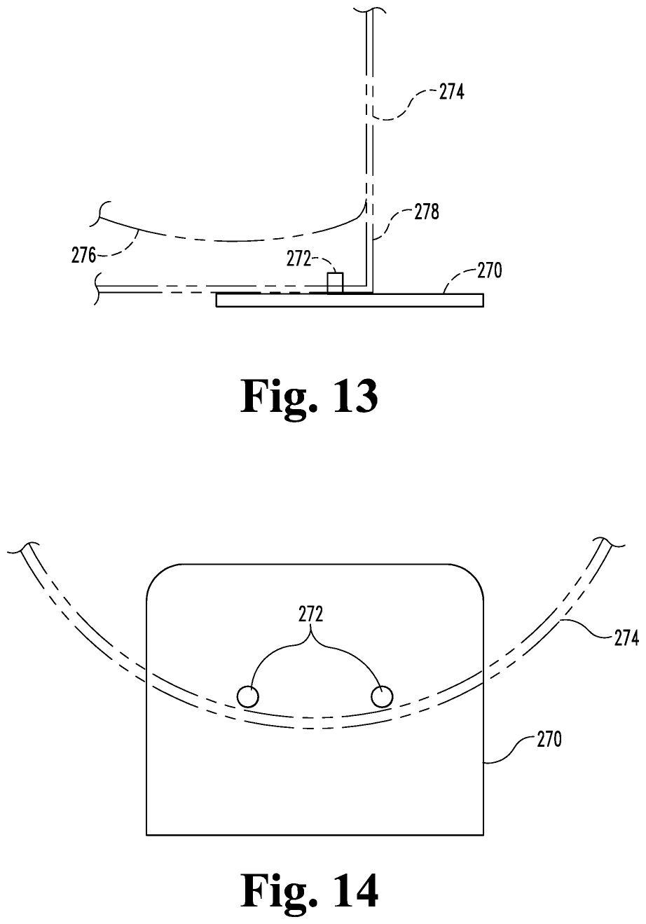

FIGS. 13-14 illustrate how one or more stabilizing pegs on a hand truck lip act to help secure and stabilize a cylinder. In this example, most components of the hand truck have been omitted and a cylinder is shown as a ghosted image for the sake of clarity. In this example, two pegs 272 are sized and arranged on lip 270 so that when cylinder 274 is tipped forward lip 270 and pegs 272 of the hand truck may be slid under stabilizing ring 278 of cylinder 274. More or fewer pegs may be used as desired. Cylinder 274 is then tipped back so that it rests on hand truck lip 270. In this position, the one or more stabilizing pegs 272 are positioned under cylinder 274 and within the curve of the cylinder's stabilizing ring 278 to help stabilize cylinder 274 on the hand truck. Pegs 272 are sized so as to prevent them from contacting and potentially damaging underside 276 of the cylinder when cylinder 274 is engaged on the hand truck. Pegs 272 are positioned on lip 270 so that they conform with the curve of the cylinder's stabilizing ring 278 so as to prevent cylinder 274 from twisting or sliding off of the hand truck during transport. In other examples, lip 270 may include more than one set of stabilizing pegs 272 to accommodate cylinders of different sizes.

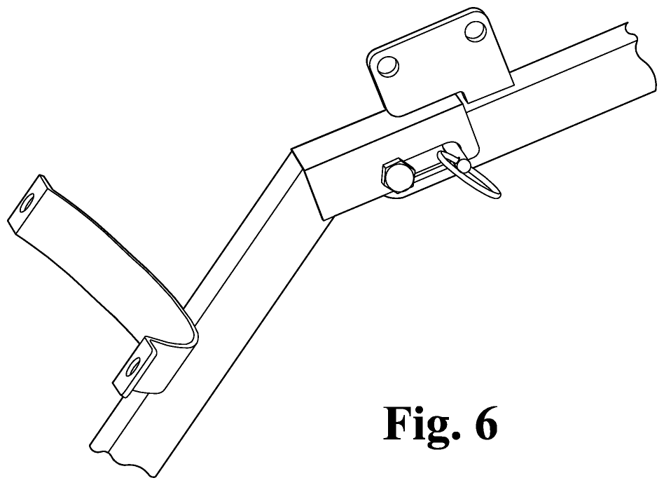

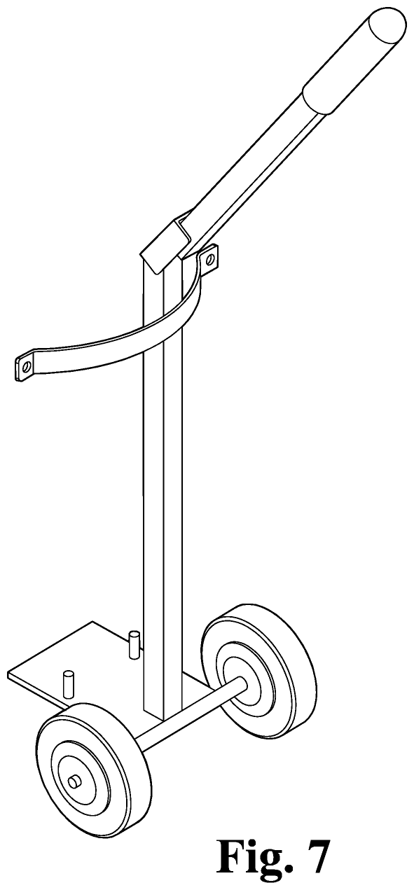

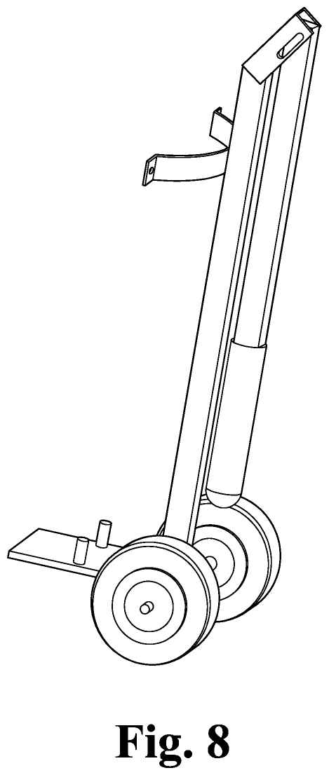

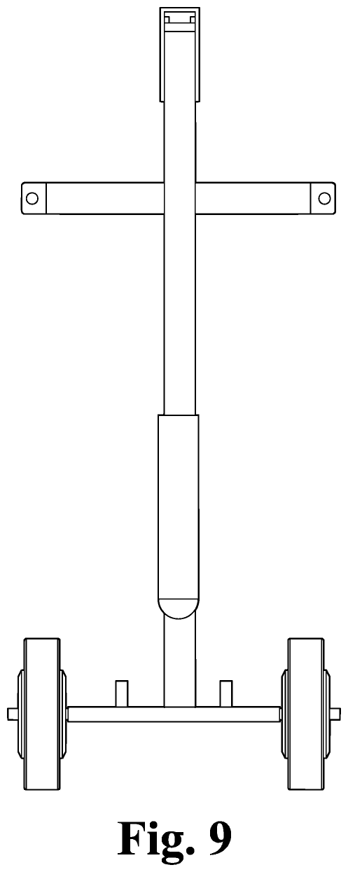

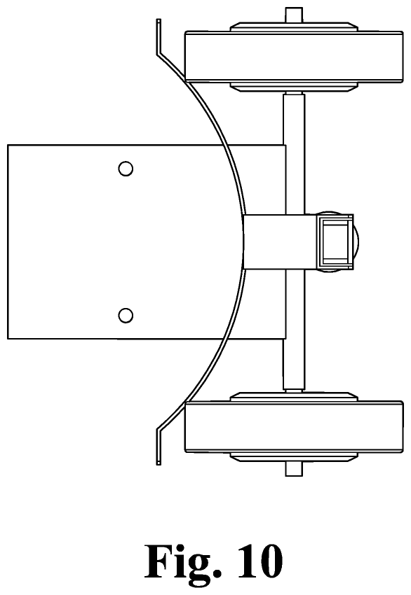

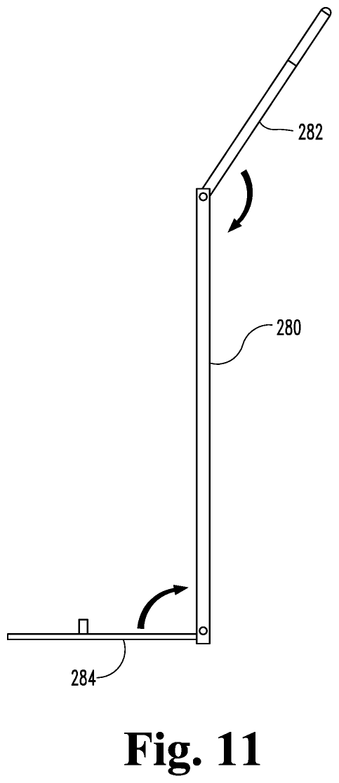

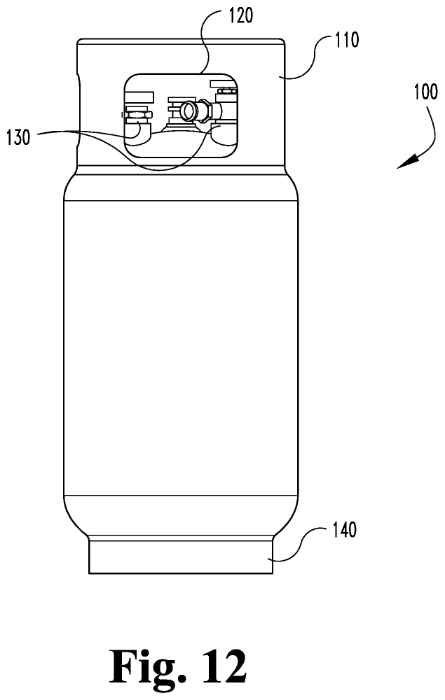

FIGS. 6-10 show other examples of the disclosed technology. FIG. 6 shows a detailed view of one example of a hinge or pivot point for folding the handle of a hand truck. The pivot point may include a latch, locking pin, or other mechanism for securing the handle in one or both of the extended and collapsed positions as desired. FIG. 7 shows a rear perspective view of a hand truck according to the disclosed technology. This example includes two stabilizing pegs on the lip portion. FIG. 8 shows the hand truck of FIG. 7 with the arm in the collapsed position. FIG. 9 shows a rear view of the hand truck of FIG. 7. FIG. 10 shows a top plan view of the hand truck shown in FIG. 7. As seen in FIG. 11, in some examples of the disclosed technology hand truck 280 may include handle portion 282 which is hinged as well as lip portion 284 which is hinged to allow the hand truck 280 to be folded and collapsed when not in use. In this example, the wheels and other features of the hand truck have been omitted for the sake of clarity.

While the claimed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the claimed technology are desired to be protected.

1. A device for holding and transporting a gas cylinder, the gas cylinder having a stabilizing ring defining an inner circumferential surface on its lower portion, comprising:
an arm portion;
a generally planar lip portion mounted to the arm portion, the arm portion disposed perpendicularly in relation to the lip portion;
at least two stabilizing pegs mounted to the lip portion; and
two wheels mounted to the lip portion;
wherein the at least two stabilizing pegs are structured and arranged to extend from the lip portion and engage the inner circumferential surface of the stabilizing ring of the gas cylinder when the lower portion of the gas cylinder is placed on the lip portion and an upper portion of the cylinder is abutting the arm portion.

2. The device of claim 1, wherein the device further comprises a hook attached to the arm portion such that the hook may engage the gas cylinder.

3. The device of claim 1, wherein the arm portion further comprises a handle portion pivotable between a raised position and a collapsed position.

4. The device of claim 3, wherein the handle portion is lockable in the raised position and the lowered position.

5. The device of claim 1, wherein the arm portion further comprises a cradle portion structured and arranged to engage and stabilize an upper portion of the gas cylinder.

6. The device of claim 5, further comprising a strap engageable with the cradle portion, the strap capable of extending around the upper portion of the gas cylinder

7. The device of claim 1 wherein the at least two stabilizing pegs conform to a shape of the inner circumferential surface of the stabilizing ring.

8. The device of claim 7 wherein the cylinder ring shape has a curve and the at least two stabilizing pegs conform to the curve of the stabilizing ring.

9. A method of transporting a gas cylinder, comprising:
tilting a gas cylinder having a stabilizing ring forward;
positioning a hand truck to engage the cylinder, the gas cylinder having a stabilizing ring defining an inner circumferential surface on a lower portion of the gas cylinder, the hand truck comprising:
an arm portion;
a lip portion mounted to the arm portion, the lip portion having a generally planar ledge adapted to support the stabilizing ring;
at least two stabilizing pegs extending from the planar ledge of the lip portion; and
two wheels mounted to the lip portion;
tilting the gas cylinder back so that the cylinder aligns against the arm and the stabilizing ring rests on the lip portion of the hand truck and the inner circumferential surface is engaged by the at least two stabilizing pegs;
tilting the hand truck and cylinder backward so that the hand truck and cylinder may be wheeled freely.

10. The method of claim 9 wherein the hand truck further comprises a hook attached to the arm portion such that the hook may engage a gas cylinder and the method comprises the further step of engaging the hook with the gas cylinder after the cylinder is engaged with the at least one stabilizing peg.

11. The method of claim 9, wherein the arm portion further comprises a cradle portion sized and configured to engage and stabilize a gas cylinder and the method further comprises the step of contacting the cylinder with the cradle after the cylinder is engaged with the at least one stabilizing peg.

12. The method of claim 11 wherein a strap is engaged with the cradle portion, and the strap extends around an upper portion of the gas cylinder to secure the gas cylinder in the hand truck.

13. The method of claim 9 wherein the at least two stabilizing pegs conform to a shape of the stabilizing ring.

14. The method of claim 13 wherein the cylinder ring shape has a curve and the at least two stabilizing pegs conform to the curve of the stabilizing ring.
